(19) United States
(12) Patent Application Publication
(10) Pub. No.: US 2026/0266400 A1
(43) Pub. Date: Sep. 10, 2026

(54) CONDUIT INSTALLATION DEVICE

(71) Applicant: Matt Lopez, Napa, CA (US)

(72) Inventor: Matt Lopez, Napa, CA (US)

(21) Appl. No.: 19/071,936

(22) Filed: Mar. 6, 2025

(51) Int. Cl. F16L 3/02

(52) U.S. Cl. CPC F16L 3/02

(57) ABSTRACT

A conduit installation device for holding a pipe includes a structural support with a base wall and a peripheral wall defining a channel. A pair of projections are positioned on opposing sides of the peripheral wall. Each projection extends into the channel and terminates in a respective lower end. An anchor is poisoned within the channel. The anchor has a height that is less than a height of the channel wherein the anchor is movable into a raised position. The anchor abuts each respective lower end of the pair of projections to exert an upward pressure on each respective lower end while the anchor is in the raised position. A rod is coupled to the anchor and includes a resiliently deformable material wherein the rod is positionable in a bent position to support a pipe. A fastener releasably secures the anchor in the raised position within the channel.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to support brackets and more particularly pertains to a new support bracket for holding a pipe during installation.

### (2) Description of Related Art Including Information Disclosed Under 37 CFR 1.97 and 1.98

The prior art relates to support brackets. Support brackets come in many different forms and are used for many different things. For example, L-shaped support brackets are often used to support shelves in a shelving unit. Other support brackets are designed to support countertops, beams, railings, and other structural units. However, the prior art lacks disclosure of support brackets that can facilitate the installation of pipes and other conduits. Pipes are typically fairly long, and those long pieces of pipe often need to be coupled together with each piece at precise angles to inhibit water from leaking out from the pipes at junctions between the pieces. Therefore, when installing long pieces of piping, one user typically needs to install fittings and straps to couple two pieces together, while other users hold the pieces of pipe in the right orientation relative to each other. Therefore, there is a need in the art for a support bracket that can temporarily hold the pieces of pipe as they are installed and attached together. Such a device would be useful to reduce the amount of time and labor costs needed for pipe installation.

### (h) BRIEF SUMMARY OF THE INVENTION

An embodiment of the disclosure meets the needs presented above by generally comprising a structural support that has a base wall and a peripheral wall extending from the base wall to define a channel. A pair of projections are coupled to the peripheral wall. Each projection of the pair of projections is positioned on a respective opposing side of a pair of opposing sides of the peripheral wall. Each projection of the pair of projections extends into the channel. The pair of projections include a pair of lower ends wherein each projection of the pair of projections terminates in a respective lower end of the pair of lower ends.

An anchor is coupled to the structural support. The anchor has a size that is complementary to a size of the channel wherein the anchor is positioned within the channel. The anchor has a height that is less than a height of the channel wherein the anchor is movable into a raised position within the channel. The anchor abuts the pair of lower ends of the pair of projections when the anchor is in the raised position wherein the anchor exerts an upward pressure on each lower end of the pair of lower ends while the anchor is in the raised position.

A rod is coupled to the anchor. The rod is centered between the pair of indentations. The rod includes a resiliently deformable material wherein the rod is selectively positionable in a bent position. The rod is configured to support a pipe proximate to the structural support while the rod is in the bent position. A fastener releasably secures the anchor in the raised position within the channel wherein the fastener is releasably engageable to secure a position of the anchor within the channel to inhibit movement of the anchor within the channel.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front exploded view of a conduit installation device according to an embodiment of the disclosure.

FIG. 2A is a detail view of an embodiment of the disclosure.

FIG. 2B is a detail view of an embodiment of the disclosure.

FIG. 3 is a front view of an embodiment of the disclosure.

FIG. 4 is a front view of an embodiment of the disclosure.

FIG. 5 is an in-use view of an embodiment of the disclosure.

FIG. 6 is a detail view of an embodiment of the disclosure.

FIG. 7 is a front view of an embodiment of the disclosure.

FIG. 8 is a detail view of an embodiment of the disclosure.

FIG. 9 is a detail view of an embodiment of the disclosure.

FIG. 10 is an in-use view of an embodiment of the disclosure.

FIG. 11 is a detail view of an embodiment of the disclosure.

FIG. 12 is an in-use view of an embodiment of the disclosure.

FIG. 13 is an in-use view of an embodiment of the disclosure.

### (J) DETAILED DESCRIPTION OF THE INVENTION

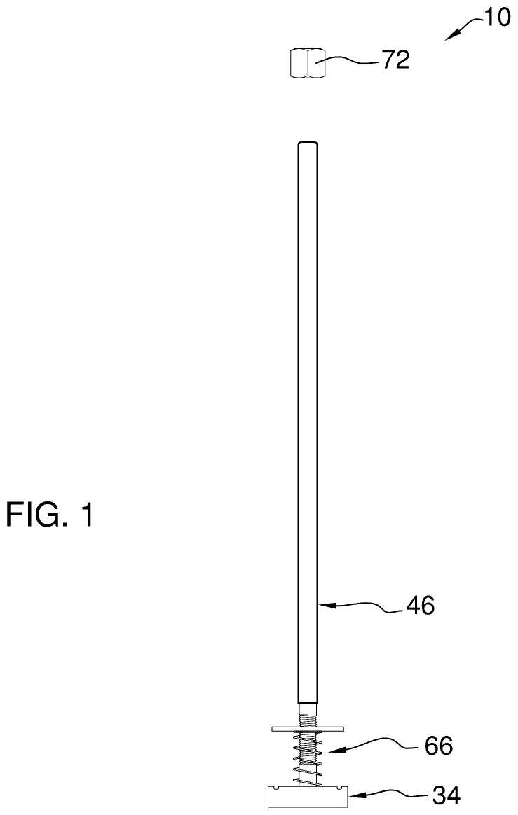

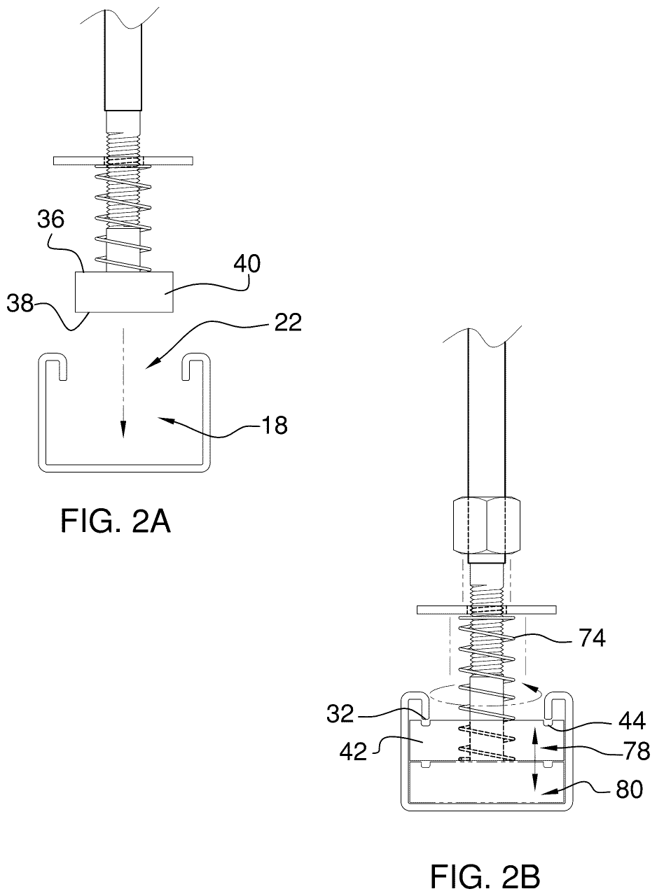

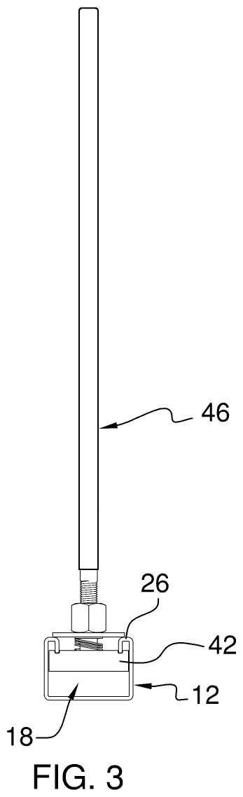

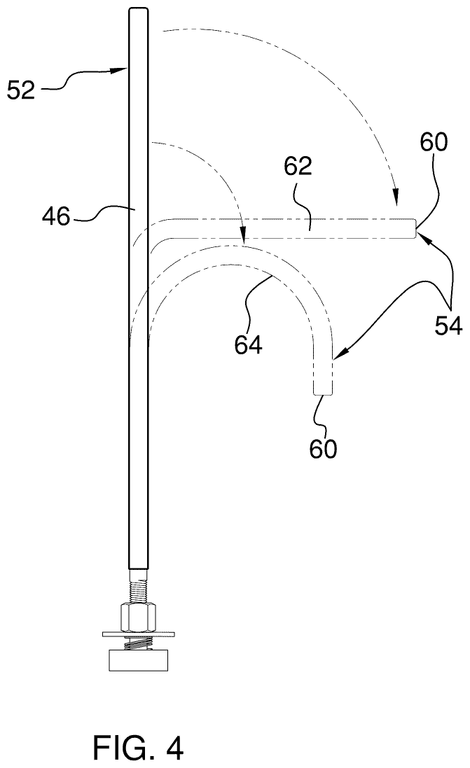

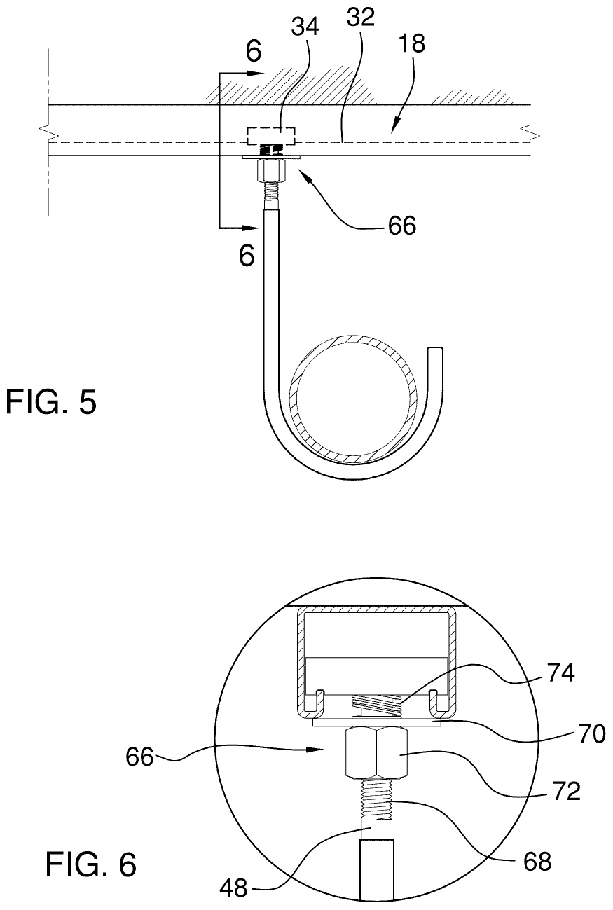

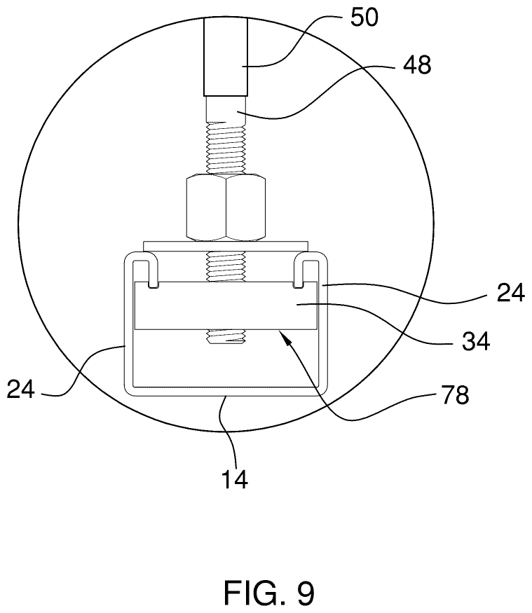

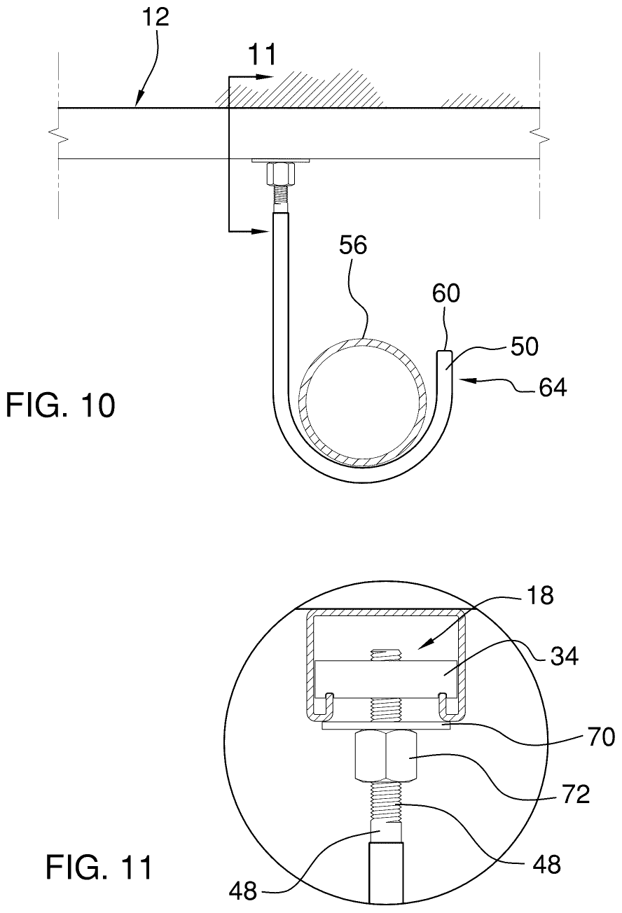

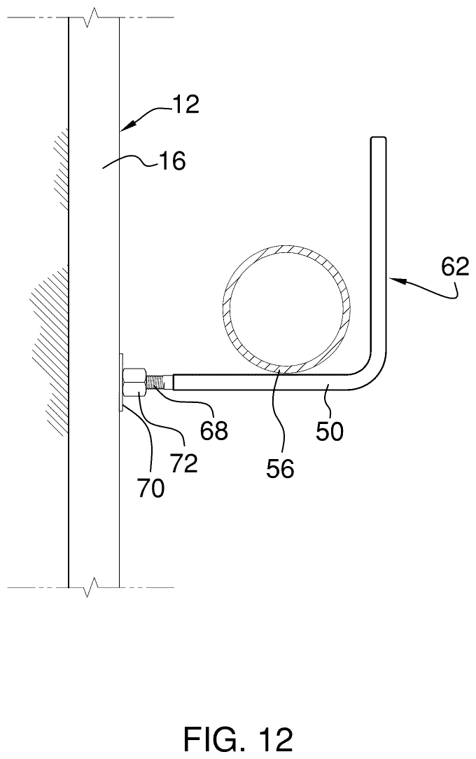

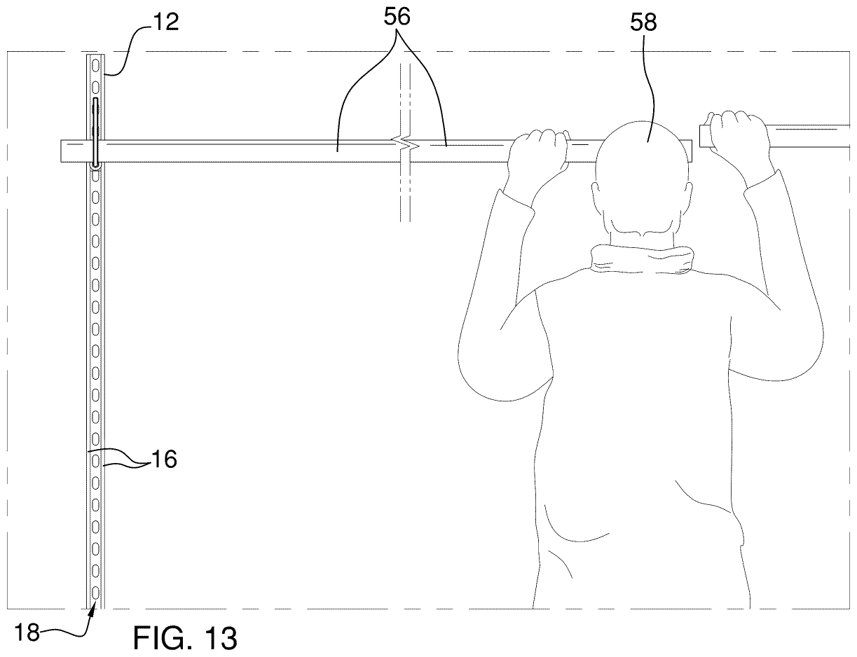

With reference now to the drawings, and in particular to FIGS. 1 through 13 thereof, a new support bracket embodying the principles and concepts of an embodiment of the disclosure and generally designated by the reference numeral 10 will be described.

As best illustrated in FIGS. 1 through 13, the conduit installation device 10 generally comprises a structural support 12 that has a base wall 14 and a peripheral wall 16 that extends from the base wall 14 to define a channel 18. The peripheral wall 16 has a pair of opposing sides 24 that are perpendicular to the base wall 14 wherein the channel 18 extends between the pair of opposing sides 24 of the peripheral wall 16. Each opposing side of the pair of opposing sides 24 has a respective forward end of a pair of forward ends 20. The pair of forward ends 20 define an opening 22 into the channel 18. The pair of forward ends 20 are distally positioned relative to the base wall 14 wherein the opening 22 faces toward the base wall 14.

A pair of projections 26 are coupled to the peripheral wall 16. Each projection of the pair of projections 26 is positioned on a respective opposing side of the pair of opposing sides 24 of the peripheral wall 16. Each projection of the pair of projections 26 generally extends outwardly and downwardly from the respective forward end of the pair of forward ends 20 into the channel 18.

The pair of projections 26 include a pair of lower ends 32 wherein each projection of the pair of projections 26 terminates in a respective lower end of the pair of lower ends 32. The pair of lower ends 32 are positioned within the channel 18. The pair of lower ends 32 are generally coplanar with each other. The pair of lower ends 32 are generally spaced from the pair of opposing sides 24 of the peripheral wall 16.

For example, each projection of the pair of projections 26 may include a horizontal member 28 that extends outwardly from the respective forward end of the pair of forward ends 20 of the peripheral wall 16. The horizontal member 28 may be perpendicular to the respective opposing side of the pair of opposing sides 24 of the peripheral wall 16. A vertical member 30 may be coupled to and extend downwardly from the horizontal member 28 into the channel 18. The vertical member 30 is generally spaced from the respective opposing side of the pair of opposing sides 24 of the peripheral wall 16. The vertical member 30 terminates at a respective lower end of the pair of lower ends 32.

An anchor 34 is coupled to the structural support 12. In preferred embodiments, the anchor 34 is removably couplable to the structural support 12. The anchor 34 has a size that is complementary to a size of the channel 18 wherein the anchor 34 is positionable within the channel 18.

For example, the anchor 34 may include a top panel 36 and a bottom panel 38. The bottom panel 38 may be parallel to the top panel 36. The bottom panel 38 may have a size that is equal to a size of the top panel 36. The anchor 34 has a height that is measured between the top panel 36 and the bottom panel 38. The height of the anchor 34 is less than a height of the channel 18 wherein the anchor 34 is movable between a raised position 78 and a lowered position 80. The anchor 34 abuts the pair of lower ends 32 when the anchor 34 is in the raised position 78 wherein the anchor 34 exerts an upward pressure on each lower end of the pair of lower ends 32 while the anchor 34 is in the raised position 78. The anchor 34 is generally spaced from the pair of lower ends 32 when the anchor 34 is in the lowered position 80, releasing the upward pressure. The raised position 78 may be vertically aligned with the lowered position 80.

A pair of short panels 40 may be coupled to and extend between the top panel 36 and the bottom panel 38. The pair of short panels 40 may be perpendicular to the top panel 36. The pair of short panels 40 generally have a length that is less than a distance between the pair of opposing sides 24 of the peripheral wall 16 of the structural support 12. The anchor 34 is positionable within the channel 18 when the pair of short panels 40 are positioned perpendicularly to the pair of opposing sides 24 of the peripheral wall 16. Therefore, the anchor 34 fits through the opening 22 into the channel 18 of the structural support 12 while the pair of short panels 40 of the anchor 34 are positioned to extend between the pair of opposing sides 24 of the peripheral wall 16.

A pair of long panels 42 extend between the pair of short panels 40. The pair of long panels 42 generally have a length that is complementary to a length between the pair of opposing sides 24 of the peripheral wall 16. More specifically, the pair of long panels 42 have a length that exceeds a distance between the pair of projections 26. The pair of long panels 42 secure the anchor 34 within the channel 18 while the pair of long panels 42 are positioned perpendicularly to the pair of opposing sides 24 of the peripheral wall 16. Therefore, the pair of projections 26 inhibit the anchor 34 from fitting through the opening 22 while the pair of long panels 42 of the anchor 34 are positioned to extend between the pair of opposing sides 24 of the peripheral wall 16.

A pair of indentations 44 extend into the top panel 36 of the anchor 34 toward the bottom panel 38. The pair of projections 26 are spaced from each other by a distance that is equal to a distance between the pair of lower ends 32 of the pair of projections 26. The pair of lower ends 32 of the pair of projections 26 are aligned with the pair of indentations 44 while the pair of long panels 42 are positioned perpendicularly to the pair of opposing sides 24 of the peripheral wall 16. An associated lower end of the pair of lower ends 32 of the pair of projections 26 is positionable within a respective indentation of the pair of indentations 44 while the anchor 34 moved fully upward into the raised position 78. The pair of indentations 44 therefore generally extend between the pair of long panels 42.

A rod 46 is coupled to the anchor 34. For example, the rod 46 may be centered between the pair of indentations 44. The rod 46 generally includes a resiliently deformable material wherein the rod 46 is selectively positionable in a straightened position 52 and a bent position 54. The rod 46 is configured to support a pipe 56 adjacent to the structural support 12 while the rod 46 is in the bent position 54.

In preferred embodiments, the rod 46 may include a primary member 48 that is positioned to extend upwardly from the top panel 36 of the anchor 34. A secondary member 50 may extend upwardly from the primary member 48. Generally speaking, the secondary member 50 includes the resiliently deformable material wherein the secondary member 50 is selectively positionable in the straightened position 52 and the bent position 54. In other words, the secondary member 50 of the rod 46 may define a platform that is configured to hold the pipe 56 adjacent to the structural support 12 while the secondary member 50 is in the bent position 54.

The secondary member 50 may have a terminal end 60 that is distally positioned relative to the primary member 48. The bent position 54 may include a perpendicular orientation 62. The terminal end 60 of the secondary member 50 may face perpendicularly outward relative to the primary member 48 while the secondary member 50 is in the perpendicular orientation 62. The bent position 54 may also have an arcuate orientation 64. While the secondary member 50 is in the arcuate orientation 64, the terminal end 60 of the secondary member 50 may face downwardly toward the primary member 48.

The resiliently deformable material is preferably semi-flexible wherein the resiliently deformable material is configured to retain the secondary member 50 in a selected one of the straightened position 52 and the bent position 54 until a user 58 repositions the secondary member 50. Examples of the resiliently deformable material include, but are not limited to, polycarbonate materials, nylon materials, acetal materials, polyethylene terephthalate glycol, thermoplastic polymers, and shape memory polymers.

A fastener 66 releasably secures the anchor 34 in the raised position 78 within the channel 18. In other words, the fastener 66 is releasably engageable to secure a position of the anchor 34 within the channel 18 and to inhibit movement of the anchor 34 within the channel 18.

The fastener 66 may include a threading 68 that is positioned externally on the rod 46. The threading 68 is generally positioned on the primary member 48. A holder 70 is generally positionable to extend between the pair of opposing sides 24 of the peripheral wall 16 of the structural support 12 while the anchor 34 is positioned within the channel 18. More specifically, the opening 22 into the channel 18 is generally positioned between the holder 70 and the anchor 34. The holder 70 may be movably positioned on the rod 46 between the anchor 34 and the secondary member 50 of the rod 46. The holder 70 may exert a downward pressure on each lower end of the pair of lower ends 32 of the pair of projections 26. The downward pressure exerted by the holder 70 and the upward pressure exerted by the anchor 34 secures the position of the anchor 34 within the channel 18. As shown in the Figures, the holder 70 may be a washer, although alternative embodiments are also contemplated.

A retainer 72 may be releasably engageable with the threading 68. The retainer 72 is generally movable upwardly and downwardly along the threading 68, for example by screwing the retainer 72 along the threading toward and away from the anchor 34. The retainer 72 inhibits upward and downward movement of the holder 70 along the rod 46 while the retainer 72 is engaged. While the retainer 72 is engaged, the retainer 72 thereby facilitates the holder 70 in exerting the downward pressure on each lower end of the pair of lower ends 32 of the pair of projections 26. The holder 70 is upwardly and downwardly moveable along the rod 46 while the retainer 72 is disengaged. While the retainer 72 is disengaged, the downward pressure exerted by the holder 70 is released to facilitate removal of the anchor 34 from the channel 18 and to decouple the anchor 34 from the structural support 12. As shown in the Figures, the retainer 72 may be a nut, although alternative embodiments are also contemplated.

The primary member 48 of the rod 46 may be integrally formed with the anchor 34, which is generally preferred in embodiments according to FIG. 1-6. The threading 68 may be spaced from a junction between the primary member 48 of the rod 46 and the anchor 34. In such embodiments, a spring 74 may be coupled to the top panel 36 of the anchor 34 wherein the spring 74 extends upwardly from the anchor 34. The spring 74 may be positioned to surround the primary member 48 of the rod 46. The spring 74 generally has a length that is less than a length of the primary member 48 of the rod 46 when the spring 74 is fully expanded.

The spring 74 may be fixedly coupled to the top panel 36 of the anchor 34 and may also be fixedly coupled to the holder 70. Expansion of the spring 74 urges the anchor 34 downwardly toward the lowered position 80. Compression of the spring 74 urges the anchor 34 upwardly within the channel 18 toward the raised position 78. The spring 74 is compressed while the retainer 72 is engaged. The spring 74 may be biased to expand wherein expansion of the spring 74 when the retainer 72 is disengaged facilities downward movement of the anchor 34 into the lowered position 80.

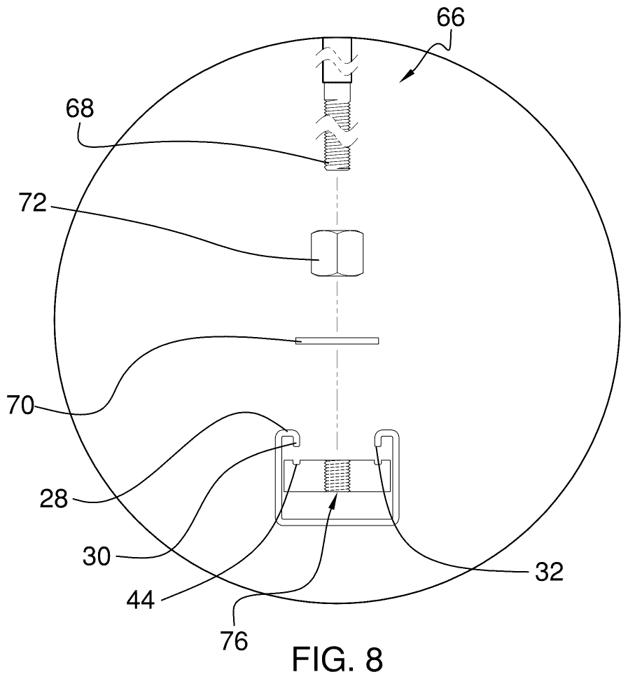

As shown in FIG. 8-11, the threading 68 may extend upwardly from a junction between the primary member 48 of the rod 46 and the anchor 34. In such embodiments, a hole 76 may extending into the top panel 36 toward the bottom panel 38 of the anchor 34. The hole 76 may even extend through the bottom panel 38 of the anchor 34. The hole 76 may be centered on the top panel 36 of the anchor 34 and on the bottom panel 38 wherein the hole 76 extends vertically through the anchor 34. Generally, the hole 76 has a size that is complementary to a size of the primary member 48 of the rod 46 wherein the primary member 48 of the rod 46 is positionable within the hole 76.

The anchor 34 may be threaded within the hole 76 wherein the threading 68 on the anchor 34 is releasably secures a position of the rod 46 within the hole 76. The anchor 34 may move upwardly toward the raised position 78 while the threading 68 is moved downwardly through the hole 76 and toward the base wall 14 of the structural support 12. The anchor 34 may move downwardly toward the lowered position 80 while the threading 68 is moved upwardly through the hole 76 and away from the base wall 14 of the structural support 12.

In use, the anchor 34 is preferably removably positionable within the channel 18. For example. A user 58 may place the anchor 34 within the channel 18 through the opening 22 while the pair of short panels 40 are positioned to extend perpendicularly between the pair of opposing sides 24 of the peripheral wall 16 of the structural support 12. The user 58 may then rotate or pivot the anchor 34 within the channel 18 to position the pair of long panels 42 of the anchor 34 perpendicularly to the pair of opposing sides 24 of the peripheral wall 16. Because the pair of long panels 42 have a length exceeding a distance between the pair of projections 26, the anchor 34 will be secured within the channel 18.

The fastener 66 can then be engaged to inhibit the anchor 34 from moving along a length of the base wall 14 of the structural support 12 within the channel 18. In other words, a size of the anchor 34 releasably secures the anchor 34 within the channel 18 while the fastener 66 releasably secures the anchor 34 in a particular position within the channel 18. The user 58 can therefore slide the anchor 34 within the channel 18 to a desired position before engaging the fastener 66 to inhibit movement of the anchor 34 within the channel 18.

In embodiments according to FIG. 1-6, the fastener 66 can be engaged by screwing the retainer 72 downwardly along the threading 68 toward the anchor 34. The threading 68 will secure a position of the retainer 72 on the primary member 48 of the rod 46. Downward movement of the retainer 72 will also urge the holder 70 downwardly toward the anchor 34, compressing the spring 74. The combined pressure of the anchor 34 and the holder 70, which is exerted in opposing directions on the peripheral wall 16 of the structural support 12, secures the position of the anchor 34 within the channel 18 to inhibit movement of the anchor 34 within the channel 18. Releasing that pressure to move the anchor 34 within the channel 18 is as easy as screwing the retainer 72 upwardly along the threading 68 away from the anchor 34.

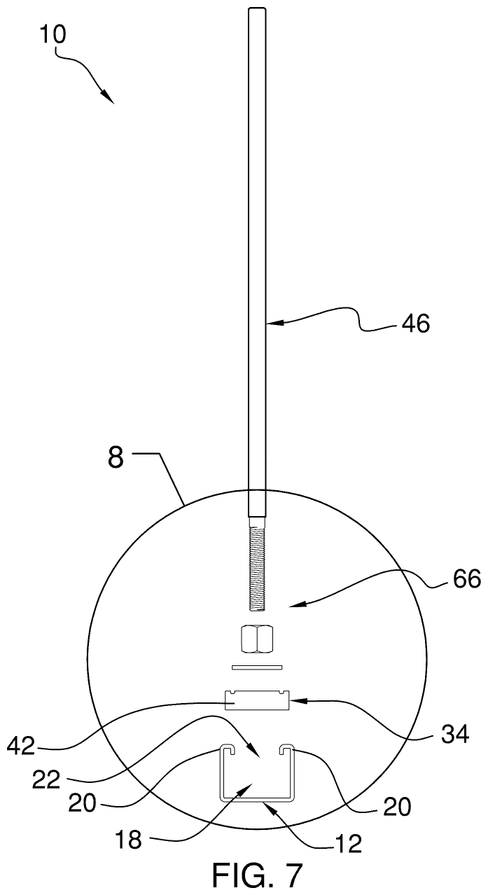

In embodiments according to FIG. 7-11, the fastener 66 can be engaged by screwing the rod 46 itself into the hole 76 extending through the retainer 72. More specifically, by screwing the threading 68 on the primary member 48 into the hole 76, the position of the primary member 48 can be secured within the hole 76. As the primary member 48 of the rod 46 moves further into the hole 76, the anchor 34 moves upwardly thorough the channel 18 toward the secondary member 50 of the rod 46. The threading 68 inhibits the rod 46 from moving within the hole 76 such that the holder 70 and the anchor 34 can exert pressure in opposing directions on the peripheral wall 16 of the structural support 12. Releasing that pressure to allow for movement of the anchor 34 within the channel 18 is as easy as unscrewing the rod 46 from the hole 76 extending through the anchor 34.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A conduit support system comprising:
a structural support having a base wall and a peripheral wall extending from the base wall to define a channel;
a pair of projections being coupled to the peripheral wall, each projection of the pair of projections being positioned on a respective opposing side of the peripheral wall, each projection of the pair of projections extending into the channel, the pair of projections including:
a pair of lower ends wherein each projection of the pair of projections terminates in a respective lower end of the pair of lower ends;
an anchor being coupled to the structural support, the anchor having a size being complementary to a size of the channel wherein the anchor is positioned within the channel, the anchor having a height being less than a height of the channel wherein the anchor is movable into a raised position, the anchor abutting the pair of lower ends when the anchor is in the raised position wherein the anchor exerts an upward pressure on each lower end of the pair of lower ends while the anchor is in the raised position;
a rod being coupled to the anchor, the rod including a resiliently deformable material wherein the rod is selectively positionable in a bent position and wherein the rod is configured to support a pipe proximate to the structural support while the rod is in the bent position;
a fastener releasably securing the anchor in the raised position within the channel wherein the fastener is releasably engageable to secure a position of the anchor within the channel to inhibit movement of the anchor within the channel.

2. The conduit support system of claim 1, the anchor further comprising:
a top panel abutting the pair of lower ends of the pair of projections when the anchor is in the raised position; and
a bottom panel, the height of the anchor being measured between the top panel and the bottom panel.

3. The conduit support system of claim 2, the anchor further comprising:
a pair of short panels being coupled to and extending between the top panel and the bottom panel, the pair of short panels having a length being less than a distance between a pair of opposing sides of the peripheral wall of the structural support wherein the anchor is positionable within the channel when the pair of short panels are positioned perpendicularly to the pair of opposing sides of the peripheral wall; and
a pair of long panels extending between the pair of short panels, the pair of long panels having a length being complementary to a length between the pair of opposing sides of the peripheral wall wherein the pair of long panels have a length exceeding a distance between the pair of projections whereby the pair of long panels secure the anchor within the channel while the pair of long panels are positioned perpendicularly to the pair of opposing sides of the peripheral wall.

4. The conduit support system of claim 2, further comprising a pair of indentations extending into the top panel of the anchor toward the bottom panel, the pair of projections being spaced from each other by a distance being equal to a distance between the pair of lower ends of the pair of projections wherein the pair of lower ends of the pair of projections are aligned with the pair of indentations.

5. The conduit support system of claim 1, wherein resiliently deformable material is semi-flexible wherein the resiliently deformable material is configured to retain the rod in a selected one of the straightened position and the bent position until a user repositions the rod.

6. The conduit support system of claim 1, the rod further comprising:
a primary member being positioned to extend upwardly from the anchor; and
a secondary member extending upwardly from the primary member, the secondary member including the resiliently deformable material wherein the secondary member is selectively positionable in the straightened position and the bent position.

7. The conduit support system of claim 6, wherein the primary member of the rod is integrally formed with the anchor.

8. The conduit support system of claim 6, the secondary member of the rod further comprising a terminal end being distally positioned relative to the primary member. the bent position of the rod further comprising:
a perpendicular orientation wherein the terminal end of the secondary member faces perpendicularly outward relative to the primary member; and
an arcuate orientation wherein the terminal end of the secondary member faces toward the primary member.

9. The conduit support system of claim 1, the fastener further comprising:
a threading being positioned externally on the rod; and
a holder being positionable to extend between a pair of opposing sides of the peripheral wall of the structural support while the anchor is positioned within the channel, the holder being movably positioned on the rod wherein the holder exerts a downward pressure on each lower end of the pair of lower ends of the pair of projections and wherein the downward pressure exerted by the holder and the upward pressure exerted by the anchor secures the position of the anchor within the channel.

10. The conduit support system of claim 9, the fastener further comprising a retainer being releasably engageable with the threading wherein the retainer is movable upwardly and downwardly along the threading, the retainer inhibiting upward and downward movement of the holder along the rod while the retainer is engaged wherein the retainer facilitates the holder in exerting the downward pressure on each lower end of the pair of lower ends of the pair of projections.

11. The conduit support system of claim 10, wherein the holder is upwardly and downwardly moveable along the rod while the retainer is disengaged wherein the downward pressure exerted by the holder is released while the retainer is disengaged.

12. The conduit support system of claim 9, the fastener further comprising a hole extending into the anchor, the anchor being threaded within the hole wherein the threading on the anchor is releasably secures a position of the rod within the hole extending through the anchor to inhibit downward movement of the anchor within the channel, the anchor moving upwardly toward the raised position while the threading is moved downwardly through the hole.

13. A conduit support system comprising:
a structural support having a base wall and a peripheral wall extending from the base wall to define a channel, the peripheral wall having a pair of opposing sides being perpendicular to the base wall wherein the channel extends between the pair of opposing sides of the peripheral wall, each opposing side of the pair of opposing sides has a respective forward end of a pair of forward ends, the pair of forward ends defining an opening extending into the channel, the pair of forward ends being distally positioned relative to the base wall wherein the opening faces toward the base wall;
a pair of projections being coupled to the peripheral wall, each projection of the pair of projections being positioned on a respective opposing side of the pair of opposing sides of the peripheral wall, each projection of the pair of projections extending outwardly and downwardly from the forward end into the channel, the pair of projections including:
a pair of lower ends wherein each projection of the pair of projections terminates in a respective lower end of the pair of lower ends, the pair of lower ends being positioned within the channel, the pair of lower ends being coplanar with each other, the pair of lower ends being spaced from the pair of opposing sides of the peripheral wall;
an anchor being couplable to the structural support, the anchor having a size being complementary to a size of the channel wherein the anchor is positionable within the channel, the anchor including:
a top panel;
a bottom panel, the anchor having a height being measured between the top panel and the bottom panel, the height of the anchor being less than a height of the channel wherein the anchor is movable between a raised position and a lowered position, the anchor abutting the pair of lower ends when the anchor is in the raised position wherein the anchor exerts an upward pressure on each lower end of the pair of lower ends while the anchor is in the raised position, the anchor being spaced from the pair of lower ends when the anchor is in the lowered position, the raised position being vertically aligned with the lowered position, the bottom panel being parallel to the top panel, the bottom panel having a size being equal to a size of the top panel;
a pair of short panels being coupled to and extending between the top panel and the bottom panel, the pair of short panels being perpendicular to the top panel, the pair of short panels having a length being less than a distance between the pair of opposing sides of the peripheral wall of the structural support wherein the anchor is positionable within the channel when the pair of short panels are positioned perpendicularly to the pair of opposing sides of the peripheral wall whereby the anchor fits through the opening into the channel of the structural support while the pair of short panels of the anchor are positioned to extend between the pair of opposing sides of the peripheral wall; and
a pair of long panels extending between the pair of short panels, the pair of long panels having a length being complementary to a length between the pair of opposing sides of the peripheral wall wherein the pair of long panels have a length exceeding a distance between the pair of projections whereby the pair of long panels secure the anchor within the channel while the pair of long panels are positioned perpendicularly to the pair of opposing sides of the peripheral wall whereby the pair of projections inhibit the anchor from fitting through the opening while the pair of long panels of the anchor are positioned to extend between the pair of opposing sides of the peripheral wall;
a pair of indentations extending into the top panel of the anchor toward the bottom panel, the pair of projections being spaced from each other by a distance being equal to a distance between the pair of lower ends of the pair of projections wherein the pair of lower ends of the pair of projections are aligned with the pair of indentations while the pair of long panels are positioned perpendicularly to the pair of opposing sides of the peripheral wall whereby an associated lower end of the pair of lower ends of the pair of projections is positionable within a respective indentation of the pair of indentations while the anchor moved fully upward into the raised position, the pair of indentations extending between the pair of long panels;
a rod being coupled to the anchor, the rod being centered between the pair of indentations, the rod including:
a primary member being positioned to extend upwardly from the top panel of the anchor; and
a secondary member extending upwardly from the primary member, the secondary member including a resiliently deformable material wherein the secondary member is selectively positionable in a straightened position and a bent position and wherein the secondary member is configured to support a pipe adjacent to the structural support while the secondary member is in the bent position, the resiliently deformable material being semi-flexible wherein the resiliently deformable material is configured to retain the secondary member in a selected one of the straightened position and the bent position until a user repositions the secondary member, the secondary member having a terminal end being distally positioned relative to the primary member, the bent position including:
a perpendicular orientation wherein the terminal end of the secondary member faces perpendicularly outward relative to the primary member; and
an arcuate orientation wherein the terminal end of the secondary member faces downwardly toward the primary member; and
a fastener releasably securing the anchor in the raised position within the channel wherein the fastener is releasably engageable to secure a position of the anchor within the channel to inhibit movement of the anchor within the channel, the fastener including:
a threading being positioned externally on the rod, the threading being positioned on the primary member;
a holder being positionable to extend between the pair of opposing sides of the peripheral wall of the structural support while the anchor is positioned within the channel wherein the opening into the channel is positioned between the holder and the anchor, the holder being movably positioned on the rod between the anchor and the secondary member of the rod wherein the holder exerts a downward pressure on each lower end of the pair of lower ends of the pair of projections and wherein the downward pressure exerted by the holder and the upward pressure exerted by the anchor secures the position of the anchor within the channel; and
a retainer being releasably engageable with the threading wherein the retainer is movable upwardly and downwardly along the threading, the retainer inhibiting upward and downward movement of the holder along the rod while the retainer is engaged wherein the retainer facilitates the holder in exerting the downward pressure on each lower end of the pair of lower ends of the pair of projections, the holder being upwardly and downwardly moveable along the rod while the retainer is disengaged wherein the downward pressure exerted by the holder is released while the retainer is disengaged to facilitate removal of the anchor from the channel to decouple the anchor from the structural support.

14. The conduit support system of claim 13, wherein the primary member is integrally formed with the anchor.

15. The conduit support system of claim 14, wherein the threading is spaced from a junction between the primary member of the rod and the anchor.

16. The conduit support system of claim 14, the fastener further comprising a spring being coupled to the top panel of the anchor wherein the spring extends upwardly from the anchor, the spring being fixedly coupled to the top panel of the anchor wherein expansion of the spring urges the anchor downwardly toward the lowered position and wherein compression of the spring urges the anchor upwardly within the channel toward the raised position, the spring being positioned to surround the primary member of the rod, the spring having a length being less than a length of the primary member of the rod when the spring is fully expanded.

17. The conduit support system of claim 16, wherein the spring is compressed while the retainer is engaged, the spring being biased to expand wherein expansion of the spring when the retainer is disengaged facilities downward movement of the anchor into the lowered position.

18. The conduit support system of claim 13, wherein the threading extends upwardly from a junction between the primary member of the rod and the anchor.

19. The conduit support system of claim 18, the fastener further comprising a hole extending into the top panel toward the bottom panel of the anchor, the hole extending through the bottom panel of the anchor, the hole being centered on the top panel of the anchor and the hole being centered on the bottom panel wherein the hole extends vertically through the anchor, the anchor being threaded within the hole wherein the threading on the anchor is releasably secures a position of the rod within the hole extending through the anchor, the anchor moving upwardly toward the raised position while the threading is moved downwardly through the hole, the anchor moving downwardly toward the lowered position while the threading is moved upwardly through the hole.
